(19) United States
(12) Patent Application Publication
(10) Pub. No.: US 2007/0053866 A1
(43) Pub. Date: Mar. 8, 2007

(54) IN-CAN AND DRY COATING ANTIMICROBIAL COMPOSITIONS HAVING HYDROXY ANALOGS OF METHIONINE AND DERIVATIVES

(75) Inventor: Ibrahim Abou-Nemeh, Lake St. Louis, MO (US)

Correspondence Address: POLSINELLI SHALTON WELTE SUELTHAUS P.C., 700 W. 47TH STREET, SUITE 1000, KANSAS CITY, MO, 64112-1802, US

(73) Assignee: NOVUS INTERNATIONAL INC., St. Louis, MO (US)

(21) Appl. No.: 11/469,967

(22) Filed: Sep. 5, 2006

Related U.S. Application Data
(60) Provisional application No. 60/714,387, filed on Sep. 6, 2005.

(51) Int. Cl. A01N 25/00

(52) U.S. Cl. 424/78.09

(57) ABSTRACT

The invention provides coating compositions that comprise antimicrobial agent comprising at least one hydroxy analog of methionine and a binder. The antimicrobial agents may be used as preservatives to inhibit a broad spectrum of microorganisms in the coating compositions.

### CROSS-REFERENCE TO RELATED APPLICATIONS

This application claims priority from Provisional Application Ser. No. 60/714,387 filed on Sep. 6, 2005, which is hereby incorporated by reference in its entirety.

### FIELD OF THE INVENTION

This invention relates to the field of coating compositions including waterborne paints and alkyd-based paints, and more particularly, to coating compositions comprising antimicrobial agents. The antimicrobial agents may be used as preservatives to inhibit a broad spectrum of microorganisms.

### BACKGROUND OF THE INVENTION

High quality waterborne coatings did not become available until the development of styrene butadiene emulsions during the 1940s. With the growing volume of waterborne coatings came a greater demand for preservation of the paint in the wet state. The presence of water in waterborne paint, known as latex paints, along with the low-molecular-weight organic additives provides an ideal environment for the growth of bacteria. Fungi (molds and yeast) can also grow in paints in the wet state, but the bacteria of the genus Pseudomonas and Enterobacter cause the most damage. One reason bacteria cause the most damage is they grow much faster than fungi under ideal conditions, doubling population as fast as every 20 minutes.

Microbial growth on paint dry film, on the other hand, is influenced by many factors. These factors make predicting and preventing microbial growth at reasonable cost a difficult task. Some of the many variables that impact growth of microorganisms on a dry coating or film is: climate, air quality, building design, substrate, landscaping and paint formulation. Mildew (fungus) and algae have some similar requirements for growth, but also different requirements as well. Both mildew and algae require moisture, oxygen, carbon, and nitrogen nutrients, trace minerals and temperature between 15° C. and 35° C. for sustainable growth.

Mallow et al. (U.S. Pat. No. 6,231,650) describe biocidal coating compositions such as paints or coatings comprising hydrated lime. The identity and concentration of the binder used in the composition is said to prolong the biocidal activity of the hydrated lime by blocking carbon dioxide from reacting with the lime.

Garner et al. (U.S. Pat. No. 5,366,004) describe a paint comprising a pigment, a liquid, a binder and a metallic constituent that inhibits microbial growth. The metallic constituent comprises copper metal, cupric carbonate, cupric hydroxide, cupric oxide, cuprous oxide, silver metal, silver oxide, zinc oxide and zinc peroxide.

The toxicity of the biocides currently used in commercial coating compositions is of concern, as these biocides can leach into the environment through contact with soil and water. To address this concern, a need exists for a wider variety of environmentally safe and effective antimicrobial coating compositions.

### SUMMARY OF THE INVENTION

One aspect of the invention provides a coating composition. The coating composition comprises an antimicrobial agent and a binder. Typically, the antimicrobial agent is a hydroxy analog of methionine or a derivative of a hydroxy analog of methionine. In some embodiments, the hydroxy analog of methionine is a metal chelate comprising zinc ions or copper ions and at least one 2-hydroxy-4-methylthio-butanoic acid that is a ligand source.

Yet another aspect of the invention provides a method for inhibiting microbial growth and/or replication in a coating composition. The method comprises adding an antimicrobial composition to the coating composition. Typically, the antimicrobial composition comprises a hydroxy analog of methionine and a binder.

Other aspects and features will be in part apparent and in part pointed out hereinafter.

### FIGURE LEGENDS

FIG. 1 is a graph illustrating the antimicrobial activity of BIOX-ASL. Water borne paint formulations without (control) or with three different concentration of BIOX-ASL were exposed to a 1.0% inoculum of Psuedomonas aeruginosa ATCC 10145 and Enterobacter aerogenes ATCC 13048 at day 0. Each paint formulation was sampled for the presence of bacteria during the next 7 days. The number of bacterial colonies was scored from 0 (no bacterial recovery) to 4 (a continuous smear of bacterial growth).

FIG. 2 is a graph illustrating the antimicrobial activity of BIOX-AWD. Water borne paint formulations without (control) or with three different concentration of BIOX-AWD were exposed to a 1.0% inoculum of Psuedomonas aeruginosa ATCC 10145 and Enterobacter aerogenes ATCC 13048 at day 0. Each paint formulation was sampled for the presence of bacteria during the next 7 days. The number of bacterial colonies was scored from 0 (no bacterial recovery) to 4 (a continuous smear of bacterial growth).

FIG. 3 is a graph illustrating the antimicrobial activity of BIOX-ASDA. Water borne paint formulations without (control) or with two different concentration of BIOX-ASDA were exposed to a 1.0% inoculum of Psuedomonas aeruginosa ATCC 10145 and Enterobacter aerogenes ATCC 13048 at day 0. Each paint formulation was sampled for the presence of bacteria during the next 7 days. The number of bacterial colonies was scored from 0 (no bacterial recovery) to 4 (a continuous smear of bacterial growth).

FIG. 4 is a graph illustrating the antimicrobial activity of BIOX-C. Water borne paint formulations without (control) or with two different concentration of BIOX-C were exposed to a 1.0% inoculum of Psuedomonas aeruginosa ATCC 10145 and Enterobacter aerogenes ATCC 13048 at day 0. Each paint formulation was sampled for the presence of bacteria during the next 7 days. The number of bacterial colonies was scored from 0 (no bacterial recovery) to 4 (a continuous smear of bacterial growth).

FIG. 5 is a bar graph illustrating the minimum inhibitory concentration (MIC) of various biocides. The MIC of FD (N-methyl-2-hydroxymethylenoxypropyl-2′hydroxypropylamine) and BIT (1,2-benzisotiazalin-3-one), used at 40% and 100%, respectively, are from K. Winkowski, “Optimizing the Use of Biocides: Blends of Actives” (ISP, 2004).

### DETAILED DESCRIPTION OF THE INVENTION

It has been discovered that hydroxy analogs of methionine are effective antimicrobial agents when added to coating compositions. As such, these compounds or formulations containing these compounds may be usefully included in coating compositions to inhibit microbe growth and/or replication during storage of the composition.

Typically, coatings or coating compositions of the present invention include an antimicrobial agent and a binder as described in more detail below. Optionally, the coatings or coating compositions may include additives in addition to an antimicrobial agent and a binder.

Further, the preferred coating compositions of the present invention have desirable mechanical properties such that when the composition dries to form a coating, the coating has a hole-free surface that is flexible and resists cracking, peeling or other deformity. The preferred compositions of the present invention inhibit growth and/or replication of microbes within the composition for a desired period of time.

Generally, the coating compositions of the present invention may be oil-based or they may be water-based. Binders adapted for use in aqueous compositions are generally of higher polarity than binders adapted for use in oil-based compositions. Suitable binders for both oil-based and water-based coating compositions are described below.

A. Antimicrobial Agents

In an exemplary embodiment, the antimicrobial agents of the invention typically will include at least one hydroxy analog of methionine. The term “hydroxy analog of methionine,” is used herein in its broadest to include the hydroxy analogs themselves, their metal chelates or metal salts, their esters, amides, and oligomers as well as derivatives of hydroxy analogs of methionine either disclosed herein or otherwise known in the art. The antimicrobial agents may optionally include additional agents selected from the group consisting of organic acids, inorganic acids and combinations thereof. Each of the antimicrobial agents is described in more detail below.

1. Metal Chelates or Metal Salts

The coating compositions and coatings of the present invention contain an antimicrobial agent. Anti-microbial agents of the invention include a class of metal chelates and metal salts. In an exemplary embodiment, the metal chelate or metal salt is a hydroxy analog of methionine. For example, the metal chelate or metal salt may comprise metal ions and ligands of a compound having Formula 1 as a source of the ligands. The compound of Formula 1 has the structure:

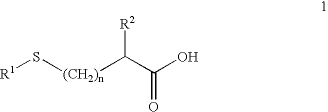

wherein:
n is an integer from 0 to 2;
R1 is methyl or ethyl; and
R2 is selected from the group consisting of hydroxyl and amino.

In various preferred embodiments of the present invention, n is 2, R1 is methyl and R2 is hydroxyl (i.e., 2-hydroxy-4-methylthio-butanoic acid, commonly known as “HMTBA” and sold by Novus International, St. Louis, Mo. under the trade name Alimet®). Preferably, the metal ions are selected from the group consisting of zinc ions, copper ions, manganese ions, iron ions, chromium ions, silver ions, cobalt ions, sodium ions, calcium ions and combinations thereof. Where the metal ion is copper, manganese, chromium, cobalt and iron, it is preferably divalent, i.e., it carries a charge of 2+. More preferably, the metal ion comprises zinc. In an alternate preferred embodiment, the metal ion comprises copper.

In various preferred embodiments of the invention, the compound of Formula 1 comprises 2-hydroxy-4-methylthiobutanoic acid (“HMTBA”), i.e., n is 2, R1 is methyl and R2 is hydroxyl. In particularly preferred embodiments, the metal ion is copper, zinc or manganese. Where the metal ion is copper or manganese, it is preferably divalent, i.e., it carries a charge of 2+. Zn cations are essentially universally divalent. In other metal chelates useful in the compositions and methods of the invention, the metal ions are also preferably divalent. The ratio of ligands to metal ion in the chelate molecule may generally vary from 1:1 to 3:1 or higher. Typically, a metal chelate may comprise a mixture of 1:1, 2:1 and 3:1 species. Preferably, the average ratio of ligands to metal ion in the chelate molecule may generally vary from 1.5:1 to 2.5:1. In an aqueous medium, the relative proportions of these species are determined by the applicable stability constants. In the case where n is 2, R2 is amino and R1 is methyl, i.e., where the compound of formula 1 is methionine, a number of the stability constants are available from the literature. At least some stability constants may also be available for the chelates in which n is 2, R2 is hydroxyl and R1 is methyl, i.e., where the compound of formula 1 is HMTBA.

Where the number of ligands equates to the charge on the metal ion, the charge is typically balanced because the carboxyl moieties of the ligands are in deprotonated form. Thus, in these chelates, each of the ligands corresponds to formula 1A: 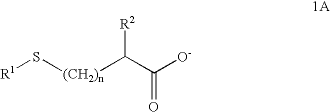
wherein R1, R2 and n are as defined above, i.e., the chelate in this respect is also a dicarboxylate salt. For example, in the chelate species wherein the metal cation carries a charge of 2+ and the ligand to metal ratio is 2:1, each of the hydroxyl or amino group (R2) groups is understood to be bound by a coordinate covalent bond to the metal while an ionic bond prevails between each of the carboxylate groups and the metal ion. Typical examples are the complexes of Zn+2, Cu+2, Mn+2 with two 2-hydroxy-4-methylthiobutanoate ions. Where the number of ligands exceeds the charge on the metal ion, e.g., in a 3:1 chelate of a divalent metal ion, the ligands in excess of the charge typically may remain in a protonated state to balance the charge. On the other hand, where the positive charge on the metal ion exceeds the number of ligands, the charge may be balanced by the presence of another anion such as, for example, chloride, bromide, iodide, bicarbonate, hydrogen sulfate, dihydrogen phosphate and combinations thereof. Divalent anions may also be present.

Metal salts wherein the metal has a 1+ or 2+ charge may also be used. These salts form when the metal reacts with one or more ligands having the structure of Formula 1 to form an ionic bond between the metal and ligand. Generally, these metal salts can be prepared by contacting a metal ion source with HMTBA. Preferably, a silver salt is used wherein a silver ion having a 1+ charge reacts with HMTBA to form a silver 2-hydroxy-4-methylthiobutanoate metal salt. This silver metal salt can be prepared by contacting silver nitrate with HMTBA.

The metal chelates of the present invention can be prepared generally according to the methods described in U.S. Pat. Nos. 4,335,257 and 4,579,962. In a preferred preparation process, a metal source compound such as a metal oxide, a metal carbonate or a metal hydroxide is charged to a reaction vessel, and an aqueous solution of HMTBA is added to the source compound. The concentration of HMTBA in the aqueous solution is preferably between about 40% and about 89% or more by weight. Reaction typically proceeds over a period of 2 hours under moderate agitation. Water and/or carbon dioxide is produced in the reaction depending on the starting material. Ordinarily, the reaction is conducted substantially at atmospheric pressure, and the reaction mass is heated to a temperature in the 90° to 130° C. range for removal of water.

After the reaction is substantially complete, heating of the reaction mass is continued in the reaction vessel to produce a substantially dried product. Ultimately, the free water content is reduced to about 2% by weight, and the product mass transitions to free-flowing particulate solid. The dried metal chelate product may optionally be mixed with a calcium bentonite filler and ground to a powder.

Further, HMTBA-Na salts can be prepared by the reaction of HMTBA and NaOH, which is a neutralization reaction of the HMTBA acid by the NaOH base. This neutralization reaction forms the HMTBA-Na salt and water.

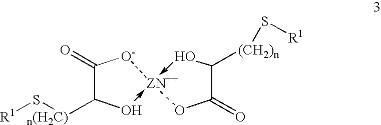

Where the carboxyl of the ligand is in deprotonated form, each of the ligands and the metal ion is believed to form a five membered ring, so that the 2:1 species has the structure:

The concentration of antimicrobial agent may vary substantially depending on the nature of the structure to which the coating composition is applied, the service in which the structure is used and other environmental conditions to which the structure is exposed, etc. Generally, the concentration of antimicrobial agent is sufficient to reduce microbial growth and/or microbial replication rate compared to that incurred in the presence of microbes under the same conditions in an identical composition except for the absence of a metal chelate, metal salt or other antimicrobial agent from the paint composition. Typically, the metal chelate or metal salt concentration in the coating composition is from about 0.0005 wt. % to about 5 wt. %. Preferably, the metal chelate or metal salt concentration in the coating composition can be from about 0.0005 wt. % to about 1 wt. %. More preferably, the metal chelate or metal salt concentration in the coating composition can be from about 0.0005 wt. % to about 0.5 wt. %. In various embodiments, the metal chelate or metal salt concentration in the coating composition can be from about 0.001 wt. % to about 0.1 wt. %. In alternative embodiments, the metal chelate or metal salt concentration in the coating composition can be from about 0.1 wt. % to about 2 wt. %; more preferably, from about 0.1 wt. % to about 1 wt. %. Usually, the metal chelate or metal salt concentration in the coating is from about 0.0006 wt. % to about 6.3 wt. %; preferably, from about 0.0006 wt. % to about 1.3 wt. %; more preferably, from about 0.0006 wt. % to about 0.6 wt. %; more preferably, from about 0.0013 wt. % to about 0.13 wt. %. In alternative embodiments, the metal chelate or metal salt concentration in the coating can be from about 0.13 wt. % to about 2.5 wt. %; more preferably, from about 0.13 wt. % to about 1.3 wt. %. But the optimal metal chelate or metal salt concentration in the coating composition or coating is dependent on the type of coating in which the metal chelate or metal salt is incorporated. For example, depending on the other components of the coating compositions and the tendency of the composition to provide an attractive medium for microbe growth and/or replication, metal chelates or metal salts may need to be present in greater or lesser amounts. But regardless of the microbe growth and/or replication rate, the concentration of the metal chelate or metal salt in the coating is preferably low enough so the coating properties of uniformity, thickness and continuity are not unduly affected. As discussed below, these variables of growth medium characteristics and coating properties of the coating composition may appropriately be considered when determining the optimum concentration of the metal chelate or metal salt in the coating compositions of the present invention.

In various embodiments, the metal chelate or metal salt may be delivered to the coating composition or coating by adding the sodium salt of HMTBA (HMTBA-Na) and a metal salt (e.g., salt of zinc, copper, manganese, and the like) to the coating composition. In certain cases, the HMTBA-Na will react with the metal salt to form a HMTBA-metal salt or chelate depending on the identity of the metal. For example, it is believed that adding HMTBA-Na and a soluble zinc salt (e.g., zinc chloride, zinc nitrate, zinc carbonate, zinc sulfate, zinc acetate, zinc formate, zinc ammonium sulfate, zinc phosphate, zinc stearate, and the like) will react by ion exchange of sodium with zinc to form, after equilibration, HMTBA-Zn chelates and Na(anion) salts.

In some cases, the particle size of the antimicrobial agent is important. For example, a commercially available copper 2-hydroxy-4-methylthiobutanoate chelate may have a grain size that is too large to produce a smooth, even dispersion in the coating matrix. In general, where the particle size of the chelate is considered too coarse for a specific application, it may be ground mechanically to a smaller particle size. To achieve a highly uniform dispersion of extended stability, and or to provide a smooth even finish, it may be desirable to reduce the metal chelate or metal salt to an average particle size of less than about 10 microns, more preferably to an average particle size in the range of about 0.2 to about 5 microns, e.g., an average particle size of about 2 microns wherein at least about 95 wt. % of the particles average an average size between about 0.05 and about 8 microns.

One or more metal chelates or metal salts may be present in the coatings or coating composition with one or more components selected from the group consisting of a compound of Formula 2, an organic acid, an inorganic acid, another biocide and combinations thereof.

2. Hydroxy Analogs of Methionine Having Formula 2

Another class of agents effective for inhibiting microbial growth and/or replication in the coatings or coating compositions of the invention is hydroxy analogs of methionine or their derivatives comprising Formula 2:

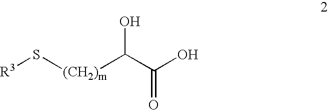

wherein
R3 is methyl or ethyl; and
m is an integer from 0 to 2; and
salts, esters, or amides thereof.

In various preferred embodiments, m is 2 and R3 is methyl (i.e., 2-hydroxy-4-methylthio-butanoic acid). An 88 wt. % HMTBA product is commercially available from Novus International, Inc. One or more compounds of Formula 2 may be present in the coatings or coating composition in combination with one or more components selected from the group consisting of a metal chelate or metal salt, an organic acid, an inorganic acid and combinations thereof.

The total concentration of the compound or compounds of Formula 2 in said coating composition is from about 0.0005 wt. % to about 5 wt. %; preferably, from about 0.0005 wt. % to about 1 wt. %; more preferably, from about 0.0005 wt. % to about 0.5 wt. %. In alternative embodiments, the concentration of the compound or compounds of Formula 2 in the coating composition can be from about 0.1 wt. % to about 2 wt. %; more preferably, from about 0.1 wt. % to about 1 wt. %. The total concentration of the compound or compounds of Formula 2 in said coating is from about 0.0006 wt. % to about 6 wt. %; preferably, from about 0.0006 wt. % to about 1.3 wt. %; more preferably, from about 0.0006 wt. % to about 0.6 wt. %. In alternative embodiments, the concentration of the compound or compounds of Formula 2 in the coating can be from about 0.13 wt. % to about 2.5 wt. %; more preferably, from about 0.13 wt. % to about 1.3 wt. %. One or more compounds of Formula 2 may be present in the coatings or coating compositions with one or more components selected from the group consisting of a metal chelate or metal salt, an organic acid, an inorganic acid, another biocide and combinations thereof.

3. Organic Acids

Another class of agents effective for inhibiting microbial growth and/or replication in the coating compositions of the present invention is organic acids. In this context, organic acids have the formula RC(O)OH wherein the R group is hydrocarbyl or substituted hydrocarbyl. One or more organic acid compounds may be present in the coating composition. Preferably, the organic acid included in the coating composition has a pKₐ value less than about 5.5.

In various embodiments of the present invention, the organic acid is selected from the group consisting of formic acid, acetic acid, propionic acid, butyric acid, benzoic acid, lactic acid, malic acid, tartaric acid, mandelic acid, citric acid, fumaric acid, sorbic acid, boric acid, succinic acid, adipic acid, glycolic acid, glutaric acid, and combinations thereof. Preferably, the organic acid is selected from the group consisting of formic acid, lactic acid, benzoic acid, propionic acid and combinations thereof.

The total concentration of the other organic acid in said coating composition is from about 0.0005 wt. % to about 5 wt. %; preferably, from about 0.0005 wt. % to about 1 wt. %; more preferably, from about 0.0005 wt. % to about 0.5 wt. %. In alternative embodiments, the concentration of the other organic acid in the coating composition can be from about 0.1 wt. % to about 2 wt. %; more preferably, from about 0.1 wt. % to about 1 wt. %. The total concentration of the organic acid in said coating is from about 0.0006 wt. % to about 6 wt. %; preferably, from about 0.0006 wt. % to about 1.3 wt. %; more preferably, from about 0.0006 wt. % to about 0.6 wt. %. In alternative embodiments, the concentration of the other organic acid in the coating can be from about 0.13 wt. % to about 2.5 wt. %; more preferably, from about 0.13 wt. % to about 1.3 wt. %. The organic acids can be combined prior to addition to the coating composition at the concentrations described above. Prior to addition, such a combination of organic acids may contain from about 50 wt. % to about 90 wt. % formic acid; preferably, from about 60 wt. % to about 85 wt. % formic acid; more preferably, from about 65 wt. % to about 80 wt. % formic acid. Prior to addition, other combinations may contain from about 10 wt. % to about 30 wt. % lactic acid; preferably, about 15 wt. % to about 25 wt. % lactic acid. Prior to addition, alternate combinations may contain from about 20 wt. % to about 60 wt. % propionic acid; preferably, from about 25 wt. % to about 40 wt. % propionic acid; more preferably, from about 30 wt. % to about 40 wt. % propionic acid.

In combinations using other organic acids, prior to addition, the combination may contain from about 50 wt. % to about 90 wt. % fumaric acid; preferably, from about 60 wt. % to about 80 wt. % fumaric acid; more preferably, from about 65 wt. % to about 75 wt. % fumaric acid. In further combinations, prior to addition to the coating composition, the organic acid combination may contain from about 10 wt. % to about 50 wt. % benzoic acid; preferably, from about 20 wt. % to about 40 wt. % benzoic acid; more preferably, from about 30 wt. % to about 40 wt. % benzoic acid.

One or more organic acids may be present in the coating composition with one or more components selected from the group consisting of a metal chelate or metal salt, a compound of Formula 2, an inorganic acid, another biocide and combinations thereof.

4. Inorganic Acids

Another class of agents effective for inhibiting microbial growth and/or replication in the coating compositions of the present invention is inorganic acids. One or more inorganic acid compounds may be present in the coating composition. The inorganic acid is selected from the group consisting of phosphoric acid, sulfuric acid, phosphorous acid, hydrochloric acid, hydrobromic acid, nitric acid and combinations thereof. Preferably, the inorganic acid is selected from the group consisting of phosphoric acid, sulfuric acid, nitric acid, hydrochloric acid, and combinations thereof. In one preferred embodiment, the inorganic acid comprises phosphoric acid.

The total concentration of the inorganic acid in said coating composition is from about 0.0005 wt. % to about 0.5 wt. %; preferably, from about 0.0005 wt. % to about 0.25 wt. %; more preferably, from about 0.0005 wt. % to about 0.1 wt. %. In alternative embodiments, the total concentration of the inorganic acid in the coating composition can be from about 0.1 wt. % to about 2 wt. %; more preferably, from about 0.1 wt. % to about 1 wt. %. The total concentration of the inorganic acid in said coating is from about 0.0006 wt. % to about 0.6 wt. %; preferably, from about 0.0006 wt. % to about 0.3 wt. %; more preferably, from about 0.0006 wt. % to about 0.13 wt. %. In alternative embodiments, the total concentration of the inorganic acid in the coating can be from about 0.13 wt. % to about 2.5 wt. %; more preferably, from about 0.13 wt. % to about 1.3 wt. %. One or more inorganic acids may be present in the coating composition with one or more components selected from the group consisting of a metal chelate or metal salt, a compound of Formula 2, an organic acid, another biocide and combinations thereof.

Various combinations of the above antimicrobial agents comprise, for example, a compound of Formula 2, an organic acid and optionally an inorganic acid. The following concentrations are based on the amounts present in a combination prior to addition to the coating composition. These combinations may include from about 10 wt. % to about 70 wt. % HMTBA; preferably, from about 25 wt. % to about 50 wt. % HMTBA; more preferably, from about 30 wt. % to about 40 wt. % HMTBA. Other combinations may include from about 20 wt. % to about 60 wt. % formic acid; preferably, from about 30 wt. % to about 55 wt. % formic acid; more preferably, from about 40 wt. % to about 50 wt. % formic acid. Other combinations may include from about 5 wt. % to about 20 wt. % lactic acid; preferably, from about 5 wt. % to about 15 wt. % lactic acid. Alternate combinations may include from about 5 wt. % to about 40 wt. % propionic acid; preferably, from about 10 wt. % to about 30 wt. % propionic acid; more preferably, from about 15 wt. % to about 25 wt. % propionic acid.

In combinations using other organic acids, the combination may include from about 20 wt. % to about 60 wt. % fumaric acid; preferably, from about 30 wt. % to about 50 wt. % fumaric acid; more preferably, from about 35 wt. % to about 45 wt. % fumaric acid. In further combinations, the organic acid combination may include from about 5 wt. % to about 40 wt. % benzoic acid; preferably, from about 10 wt. % to about 30 wt. % benzoic acid; more preferably, from about 15 wt. % to about 25 wt. % benzoic acid.

Various preferred combinations include from about 30 wt. % to about 40 wt. % HMTBA and from about 40 wt. % to about 50 wt. % formic acid. Other combinations include from about 30 wt. % to about 40 wt. % HMTBA, from about 40 wt. % to about 50 wt. % formic acid and from about 5 wt. % to about 15 wt. % lactic acid. Yet other combinations include from about 30 wt. % to about 40 wt. % HMTBA, from about 40 wt. % to about 50 wt. % formic acid, from about 5 wt. % to about 15 wt. % lactic acid and from about 5 wt. % to about 15 wt. % phosphoric acid.

Alternate preferred combinations include from about 30 wt. % to about 40 wt. % HMTBA, from about 40 wt. % to about 50 wt. % formic acid and from about 15 wt. % to about 25 wt. % propionic acid.

Further combinations include from about 30 wt. % to about 40 wt. % calcium bis(2-hydroxy-4-methylthiobutanoate) and from about 35 wt. % to about 45 wt. % fumaric acid. Preferably, these combinations include from about 30 wt. % to about 40 wt. % calcium bis(2-hydroxy-4-methylthiobutanoate), from about 35 wt. % to about 45 wt. % fumaric acid and from about 15 wt. % to about 25 wt. % benzoic acid.

In various preferred embodiments, the antimicrobial agent is selected from the group consisting of HMTBA-Zn, HMTBA-Cu, BIOX-ASL, BIOX-ASDA, BIOX-AWD and combinations thereof. HMTBA-Zn is a zinc chelate of HMTBA, HMTBA-Cu is a copper chelate of HMTBA, BIOX-ASL contains 35 wt. % of 2-hydroxy-4-methylthio butanoic acid (88%), 45 wt. % of formic acid, 10 wt. % phosphoric acid and 10 wt. % lactic acid; BIOX-AWD contains 40 wt. % of 2-hydroxy-4-methylthio butanoic acid, 40 wt. % of formic acid and 20 wt. % propionic acid; BIOX-ASDA contains 36.4 wt. % of calcium bis(2-hydroxy-4-methylthiobuanoate), 41.9 wt. % of fumaric acid, 20 wt. % of benzoic acid, 0.9 wt. % flow aid and 0.73 wt. % other additives.

5. Other Biocides

Biocidal agents (“auxiliary biocides”) different in composition from the antimicrobial agents for paint preservation described above (“primary antimicrobial agents”) may optionally be included in the coating compositions of the present invention. Generally, these auxiliary biocides act inhibit the growth and/or replication of microbes in the coating compositions and/or the coatings of the present invention. In some cases, the auxiliary biocides are particularly suited to inhibit the growth and/or replication of microbes in the coating compositions prior to application, whereas another set of auxiliary biocides are particularly suited to inhibit the growth and/or replication of microbes in dry coatings.

An advantage of the combination of a primary antimicrobial agent and an auxiliary biocide is retention of the effectiveness of the combination for inhibiting microbial growth and/or microbial replication while reducing the toxicity of the combination due to a decrease in the amount of auxiliary biocide necessary to inhibit such microbial growth and/or replication. Generally, the primary antimicrobial agents discussed above are less toxic to the environment once leached out of the paint than the other biocides contemplated herein.

In various preferred embodiments, the primary antimicrobial agents of the present invention are incorporated into the coating compositions in combination with various auxiliary biocidal agents. These auxiliary biocidal agents are suited for inhibition of microbe growth and/or replication in coating compositions, and can be, for example, formaldehyde releasers (e.g., hexahydro-1,3,5-tris(2-hydroxyethyl)-s-triazine, oxazolidines (e.g., 4,4 dimethyl-1,3-oxazolidine), quaternized salts of hexamethylenetetramine (HTA)(e.g., 1-(3-chloroallyl)-3,5,7-triaza-1-azoniaadamantane chloride and methyl-3,5,7-triaza-1-azoniaadamantane chloride), bronopol (e.g., 2-bromo-2-nitropropane-1,3-diol), 1,2-dibromo-2,4-dicyanobutane (DBDCB) and combinations thereof.

Preferred combinations of primary antimicrobial agents and auxiliary biocidal agent(s) in coating compositions are (1) HMTBA-Zn, HMTBA-Cu, BIOX-ASL, BIOX-ASDA and/or BIOX-AWD with formaldehyde releasers such as triazines (e.g., hexahydro-1,3,5-tris(2-hydroxyethyl)-s-triazine); (2) HMTBA-Zn, HMTBA-Cu, BIOX-ASL, BIOX-ASDA and/or BIOX-AWD with oxazolidines such as 4,4-dimethyl-1,3-oxazolidine; (3) HMTBA-Zn, HMTBA-Cu, BIOX-ASL, BIOX-ASDA and/or BIOX-AWD with quaternized salts of hexamethylenetetramine (HTA) such as 1-(3-chloroallyl)-3,5,7-triaza-1-azoniaadamantane chloride and methyl-3,5,7-triaza-1azoniaadamantane chloride; (4) HMTBA-Zn, HMTBA-Cu, BIOX-ASL, BIOX BIOX-ASDA and/or BIOX-AWD with bronopol (i.e., 2-bromo-2-nitropropane-1,3-diol); and (5) HMTBA-Zn, HMTBA-Cu, BIOX-ASL, BIOX-ASDA and/or BIOX-AWD with 1,2-dibromo-2,4-dicyanobutane (DBDCB).

In particular combinations, the total concentration of the primary antimicrobial agent or agents combined with the auxiliary biocides in the coating compositions is from about 0.0005 wt. % to about 5 wt. %; preferably, from about 0.0005 wt. % to about 1 wt. %; more preferably, from about 0.0005 wt. % to about 0.5 wt. %; more preferably, from about 0.001 wt. % to about 0.5 wt. %. In alternative embodiments, the total concentration of the primary antimicrobial agent or agents combined with the auxiliary biocides in the coating compositions is from about 0.1 wt. % to about 2 wt. %; preferably, from about 0.1 wt. % to about 1 wt. %. In the above combinations, the total concentration of the primary antimicrobial agent or agents combined with the auxiliary biocides in the coating is from about 0.0006 wt. % to about 6.3 wt. %; preferably, from about 0.0006 wt. % to about 1.3 wt. %; more preferably, from about 0.0006 wt. % to about 0.6 wt. %; more preferably, from about 0.0013 wt. % to about 0.6 wt. %. In alternative embodiments, the total concentration of the primary antimicrobial agent or agents combined with the auxiliary biocides in the coatings is from about 0.13 wt. % to about 2.5 wt. %; preferably, from about 0.13 wt. % to about 1.3 wt. %.

In various preferred embodiments, the primary antimicrobial agents of the present invention are incorporated into the coating in combination with various auxiliary biocidal agents suited to inhibit microbial growth and/or microbial replication in or on dry coatings. These other biocidal agents can be, for example, 3-iodo-2-propynyl butylcarbamate, carbendazims (e.g., N-benzimidazolyl-2-carbamic acid methyl ester (BCM)), chlorothalonil (i.e., 2,4,5,6-tetrachloroisophthaonitrile), folpet (i.e., trichloromethylthiophthalimide), methyl and chloromethyl isothiazolones, 2-n-octyl-4-isothiazolin-3-one (OIT), dichloro-2-n-octyl-4-isothiazolin-3-one (DCOIT), azoles (e.g., tebuconazole, propiconazole and thiabendazole), di-idomethyl-p-tolylsulfone, and combinations thereof.

Preferred combinations of primary antimicrobial agents and auxiliary biocidal agent(s) in the coatings are (1) HMTBA-Zn, HMTBA-Cu, BIOX-ASL, BIOX-ASDA and/or BIOX-AWD with 3-iodo-2-propynyl butylcarbamate; (2) HMTBA-Zn, HMTBA-Cu, BIOX-ASL, BIOX-ASDA and/or BIOX-AWD with carbendazims (e.g., N-benzimidazolyl-2-carbamic acid methyl ester (BCM)); (3) HMTBA-Zn, HMTBA-Cu, BIOX-ASL, BIOX-ASDA and/or BIOX-AWD with chlorothalonil (i.e., 2,4,5,6-tetrachloroisophthaonitrile); (4) HMTBA-Zn, HMTBA-Cu, BIOX-ASL, BIOX BIOX-ASDA and/or BIOX-AWD with folpet (i.e., trichloromethylthiophthalimide); (5) HMTBA-Zn, HMTBA-Cu, BIOX-ASL, BIOX BIOX-ASDA and/or BIOX-AWD with methyl and chloromethyl isothiazolones; (6) HMTBA-Zn, HMTBA-Cu, BIOX-ASL, BIOX BIOX-ASDA and/or BIOX-AWD with 2-n-octyl-4-isothiazolin-3-one (OIT); (7) HMTBA-Zn, HMTBA-Cu, BIOX-ASL, BIOX BIOX-ASDA and/or BIOX-AWD with dichloro-2-n-octyl-4-isothiazolin-3-one (DCOIT); (7) HMTBA-Zn, HMTBA-Cu, BIOX-ASL, BIOX BIOX-ASDA and/or BIOX-AWD with azoles (e.g., tebuconazole, propiconazole and thiabendazole); and (8) HMTBA-Zn, HMTBA-Cu, BIOX-ASL, BIOX-ASDA and/or BIOX-AWD with di-idomethyl-p-tolylsulfone.

In these combinations in the coatings, the total concentration of the primary antimicrobial agent or agents combined with the auxiliary biocides is from about is from about 0.0006 wt. % to about 6.3 wt. %; preferably, from about 0.0006 wt. % to about 1.3 wt. %; more preferably, from about 0.0006 wt. % to about 0.6 wt. %; more preferably, from about 0.0013 wt. % to about 0.6 wt. %. In alternative embodiments, the total concentration of the primary antimicrobial agent or agents combined with the auxiliary biocides in the coatings is from about 0.13 wt. % to about 2.5 wt. %; preferably, from about 0.13 wt. % to about 1.3 wt. %.

For the above combinations of primary antimicrobial agents and auxiliary biocidal agents in coating compositions and coatings, the ratio of antimicrobial agent to other biocidal agent(s) is from about 1:100 to about 100:1; preferably, from about 1:10 to about 10:1; more preferably, from about 1:5 to about 5:1; even more preferably, from about 1:2 to about 2:1. Thus, the terms “primary” and “auxiliary” are used herein merely to distinguish different categories of antimicrobial agent and not to indicate that the “primary” antimicrobial agent is necessarily or even desirably present in higher concentration than the “auxiliary” biocide.

In certain coating compositions, metal chelates may be used to stabilize one or more of the other biocides present in the composition. This stabilization by metal chelates can take place, for example, by reducing the deactivation of 2-methyl-4-isothiazalin-3-one (MIT), 5-chloro-2-methyl-4-isothiazalin-3-one (CIT), 1,2-benzisotiazalin-3-one (BIT) and combinations thereof by amines, sulfides, sulfites, thiols, oxidizing agents, reducing agents and combinations thereof. To reduce this deactivation and maintain a higher activity of MIT, CIT and BIT as biocides in the coating compositions, the addition of metal chelates, particularly HMTBA-Cu is believed to be advantageous. In this particular application, the concentration of HMTBA-Cu added to the composition is from about 0.001 wt. % to about 1 wt. %; preferably, from about 0.01 wt. % to about 1 wt. %; more preferably, from about 0.1 wt. % to about 1 wt. %.

B. BINDER

The coating compositions of the present invention comprise an antimicrobial agent and a binder. The binder is a film-forming ingredient that binds the particles together in a coating composition. Here, the binder may be a drying oil, a resin or an inorganic binder. Typically, different binders are used for oil-based coating compositions and water-based coating compositions. For oil-based coating compositions, the binder is soluble, miscible or dispersible with an organic solvent. For example, as described in more detail below, binders used in oil-based compositions are typically drying oils or alkyd resins. In water-based coating compositions, the binder is soluble or miscible with an aqueous solvent or emulsified or otherwise dispersed in an aqueous solvent. For example, as described in more detail below, binders used in water-based coating compositions are typically vinyl or acrylic resins.

Drying oils can be included in oil-based coating compositions as a binder. Generally, drying oils comprise glycerides of fatty acids that have varying degrees of unsaturation. Saturated glycerides may also be present. They are called drying oils because they absorb oxygen from the atmosphere that reacts with the unsaturated glycerides to generate oxygenated functional groups that further react to cross-link the fatty acid chains and form a hard, flexible film. Typically, drying oils are selected from the group consisting of linseed oil, walnut oil, poppy seed oil, ricinene oil, soya oil, castor oil and combinations thereof.

Resins can be used in both oil-based coating compositions and water-based coating compositions. A resin can be natural or synthetic and can comprise solid or semisolid viscous substances that either are obtained as exudations from certain plants or are prepared by polymerization of simple molecules.

In addition to drying oils, alkyd resins are typically included in oil-based coating compositions as a binder. Although alkyd resins can be used in both oil-based and water-based coating compositions, they are generally used more widely in oil-based coating compositions. Alkyd resins are the condensation products of polyhydric alcohols (e.g., glycerol, pentaerythritol), polybasic acids or anhydrides (e.g., phthalic anhydride and oils or monobasic fatty acids.

Acrylic and vinyl resins are the most widely used resins in water-based coating compositions. Some water-based coating compositions are latex compositions, which are water-thinned paints wherein the binder comprises a polyvinyl acetate (PVA), styrene butadiene or acrylic resin. In various preferred embodiments, the binder comprises an acrylic resin.

Acrylic, vinyl, PVA and styrene butadiene resins may be included in the coating composition at concentrations from about 10 wt. % to about 30 wt. %; preferably, from about 10 wt. % to about 20 wt. %; more preferably, from about 11 wt. % to about 17 wt. %. Acrylic, vinyl, PVA and styrene butadiene resins can be included in the coatings at concentrations from about 13 wt. % to about 38 wt. %; preferably, from about 13 wt. % to about 25 wt. %; more preferably, from about 14 wt. % to about 21 wt. %.

In addition, inorganic binders can be used in the coating compositions of the present invention. Suitable inorganic binders include calcium hydroxide (in the form of lime), lime hydrate, white cement, potassium silicate (e.g., potash waterglass) and mixtures of alkali metal silicates with polymer dispersions (e.g., styrene-acrylate copolymers).

C. Additives

In various embodiments, the coating compositions also contain additives. Additives may be selected from the group consisting of diluents, pigments, fillers, biocides and combinations thereof. The diluent for oil-based coating compositions is selected from the group consisting of alcohols, aliphatic, cycloaliphatic and aromatic hydrocarbons, ketones, ether alcohols, esters, chlorinated hydrocarbons and combinations thereof. Typically, the diluent may function as a solvent for the antimicrobial agent and/or for a binder of the composition. Preferably, the diluent for oil-based coating compositions is selected from the group consisting of methanol, ethanol, propanol, isopropanol, butanol, isobutanol, benzyl alcohol, white spirit, cyclohexane, toluene, xylene, methyl ethyl ketone, acetone, methyl isobutyl ketone, methyl isoamyl ketone, diacetone alcohol, cyclo-hexanone, 2-butoxyethanol, propylene glycol monomethyl ether, butyl diglycol, methoxypropyl acetate, n-butyl acetate, 2-ethoxyethyl acetate, methylene chloride, tetrachloroethane, trichloroethylene and combinations thereof.

For water-based coating compositions, the diluent comprises water or mixtures of water and other solvents or solvent mixtures that are miscible with water such as methanol, ethanol, propanol and the like.

Preferably, the diluent is present in the coating compositions in a concentration from about 10 wt. % to about 35 wt. %; preferably, from about 15 wt. % to about 25 wt. %; more preferably, from about 18 wt. % to about 22 wt. %.

In the coatings of the present invention, typically, the diluent evaporates after the coating composition is applied to the substrate. Therefore, the dried and/or cured coatings have a minimal concentration of diluents in the coating.

In general, pigments may be contained in the coating compositions and coatings. Pigments, for example, can be organic or inorganic pigments. Typical pigments for use in coatings are selected from the group consisting of phthalo blue, hansa yellow, ochres, umbers, Quinacridone Red, Pigment Red, Phthalocyanine Blue, Phthalocyanine Green, Perylene Red, carbon black, rutile and anatase titanium dioxides, lithopone, zinc sulfide, lead titanate, antimony oxide, zirconium oxide, barium sulfide, white lead, zinc oxide, leaded zinc oxide, red iron oxide, brown oxide, aluminum powder, vapor-deposited aluminium powder, alumina powder, nickel powder, copper powder, brass powder, chromium powder, nacreous pearl mica powder and nacreous colored pearl mica powder and combinations thereof.

Pigments may be present in the coating compositions in concentrations from about 5 wt. % to about 25 wt. %; preferably, from about 10 wt. % to about 20 wt. %; more preferably, from about 12 wt. % to about 17 wt. %. Typically, pigments may be present in the coatings in concentrations from about 6 wt. % to about 31 wt. %; preferably, from about 13 wt. % to about 25 wt. %; more preferably, from about 15 wt. % to about 21 wt. %.

Fillers are materials that usually have a fine particle size, are dispersible in organic and/or aqueous media and do not settle once dispersed. Exemplary fillers are selected from the group consisting of calcium carbonate, iron oxide, kaolin, clay, titanium dioxide, alumina trihydrate, pyrophyllite, quartz, silica, fumed silicas, precipitated silicas, silicates, barium sulfate, antimony oxide, mica, calcium sulfate, magnesium hydroxide, feldspar, nepheline syenite, carbon black filler, titanates, talc, gypsum, silex, wollastonite, bagasse, coconut hull/fiber, cork, corn, cotton-based, filsonite, nutshell flour, rice hull, sisal/hemp, soybean, starch wood flour and combinations thereof.

Fillers may be present in the coating compositions in concentrations from about 25 wt. % to about 50 wt. %; preferably, from about 30 wt. % to about 45 wt. %; more preferably, from about 35 wt. % to about 45 wt. %. Typically, fillers can be present in the coatings in concentrations from about 31 wt. % to about 63 wt. %; preferably, from about 37 wt. % to about 56 wt. %; more preferably, from about 44 wt. % to about 56 wt. %.

In addition, the coating compositions of the present invention may optionally contain extenders, thickeners, thixotropic agents, suspending agents, defoamers, foam preventatives, water softening agents and other functional components known to those of skill in the art.

D. Paint Formulations

The coating compositions of the present invention can be formulated in various ways. An exemplary water-based paint formulation follows.

| | | Silicone | |
|---|---|---|---|
| | Acrylic | Additive | Siloxanic |
| | Paint | Paint | Paint |
| INGREDIENTS | Weight | Weight | Weight |
| Water | 20.7 | 19.8 | 19.4 |
| Cellulosic Thickener | 0.2 | 0.2 | 0.2 |
| Dispersing Agent | 0.5 | 0.5 | 0.3 |
| Wetting Agent | 1.5 | 1.5 | 0.5 |
| HEUR Thickener | 1 | 1 | — |
| Defoamer | 0.2 | 0.2 | 0.1 |
| Neutralizing Agent | — | 0.2 | — |
| TiO2 | 15 | 15 | 12.5 |
| CaCO3 | 27 | 27 | 32.3 |
| Talc | 10 | 10 | 7.5 |
| Acrylic Binder | 17 | 16 | 11.1 |
| RHODORSIL ® BP 9800 Silicone | — | — | 9.2 |
| Resin Emulsion | | | |
| Defoamer | 0.2 | 0.2 | 0.1 |
| Coalescent Aid | 2.4 | 2.4 | 1.4 |
| Biocide | 0.1 | 0.1 | 0.1 |
| RHODORSIL ® BP 9900 Silicone | — | 1 | — |
| Additive | | | |
| Water | 4.2 | 4.9 | 5.2 |
| TOTAL | 100 | 100 | 100 |
| Paint Characteristics | | | |
| Density | 1.55 | 1.57 | 1.59 |
| Weight Solids % | 61 | 61 | 67 |
| Volume Solids % | 40 | 41 | 47 |
| PVC % | 67 | 64 | 63 |

In siloxanic paints, silicone resins are used as co-binders, for example, in a ratio of more than about 40% relative to the binder. These resins help to control water uptake and breathability. An additive such as RHODORSIL® BP 9900 may be added to improve the water uptake and provide an improved beading effect.

Using a hydrophobe modified associative thickener can significantly enhance the rheological properties of waterborne latex paints. Schaller and Sperry discuss rheology control and a classification of associative thickeners in Handbook of Coatings Additives, Vol. 2, L. J. Calbo, Ed., Marcel Dekker, Inc., 1992, pp 105-163. When associative thickeners are used in latex paint formulas, formulation sensitivity is often a problem. This sensitivity results from interaction between the associative thickener and other formulation additives such as salts, surfactants, latex particles, pigment particles, and coalescing aids.

Hydrophobe modified ethoxy urethane thickeners (HEUR) contain so-called telechelic molecules (hydrophobes attached to the polymer endgroups). HEUR thickeners have a single stress relaxation time and exhibit shear thickening at low shear rates under the right combination of molecular weight and at semi-dilute concentrations. At high shear rates they exhibit shear thinning and at higher concentrations exhibit pseudo-plastic behavior.

E. Microbes

The antimicrobial agents contained in the coating compositions of the present invention are effective for inhibiting the growth and/or replication of microbes in the coating composition as well as the coating once it is applied. Generally, the antimicrobial agents of the present invention are effective for inhibiting the growth and/or replication of mold and mildew. In particular, the antimicrobial agents are effective for inhibiting, for example, Pennicillium, Aspergillus, Pseudomonas sp, spore-forming bacteria, Enterobacter, Alcaligenes sp., Citrobacter sp., Klebslielia sp, Proteus-Providencia sp., Serrata sp., Escherichia sp., Gram-positive bacteria such as Staphyloccocus and Streptococcus. Yeast and fungi, e.g., Candida albicans, Aureobsaidium pullulans, Cladosporium cladosporoides, Trichoderma viride, Alternia alternate. Algae, e.g., chlorella pyrenoidosa, Ulothrix acuminate, Anabaona flos-aquae, Nostoo commune, Oscillatoria profilera etc.

F. Methods

The methods of the invention for inhibiting microbe growth and/or replication in coating compositions use the antimicrobial agents, as described above in section A, for treating coating compositions comprising the coating components as described above in sections B to D, and are effective for inhibiting the growth and/or replication of microbes described above in section E. These methods are particularly useful for coating compositions selected from the group consisting of paints, stains, lacquers, shellacs, varnishes and combinations thereof.

Definitions

“Anti-microbial” is an agent that inhibits the growth, replication, or growth and replication of a microorganism. In the context of this definition, the word “inhibit” is used in its broadest sense to include the complete or partial inhibition of microbial growth and/or replication, including minimization or prevention of growth, replication, and/or growth and replication.

“HMTBA” stands for 2-hydroxy-4(methylthio)butanoic acid.

The terms “hydrocarbon” and “hydrocarbyl” as used herein describe organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 20 carbon atoms.

The “substituted hydrocarbyl” moieties described herein are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, carbocycle, aryl, heterocyclo, alkoxy, alkenoxy, alkynoxy, aryloxy, hydroxy, protected hydroxy, keto, acyl, acyloxy, nitro, amino, amido, nitro, cyano, thiol, ketals, acetals, esters and ethers.

Having described the invention in detail, it will be apparent that modifications and variations are possible without departing the scope of the invention defined in the appended claims. Furthermore, it should be appreciated that all examples in the present disclosure are provided as non-limiting examples.

### EXAMPLES

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

In-Can Paint Preservatives

Paint preservatives listed in the tables below were added at the listed concentrations to water borne paint formulations. BIOX-ASL contains 35 wt. % of 2-hydroxy-4-methylthio butanoic acid (88%), 45 wt. % of formic acid, 10 wt. % phosphoric acid and 10 wt. % lactic acid; BIOX-AWD contains 40 wt. % of 2-hydroxy-4-methylthio butanoic acid, 40 wt. % of formic acid and 20 wt. % propionic acid; BIOX-ASDA contains 36.4 wt. % of calcium bis(2-hydroxy-4-methylthiobuanoate), 41.9 wt. % of fumaric acid, 20 wt. % of benzoic acid, 0.9 wt. % flow aid and 0.73 wt. % other additives; HTA and BIOBAN BP30 are commercially available; BIOX-Z is a HMTBA-Zn metal chelate, and BIOX-C is a HMTBA-Cu metal chelate.

| Antimicrobial Agent | Concentrations | |
|---|---|---|
| BIOX-ASL | 10, 100, 1000 | ppm |
| BIOX-AWD | 10, 100, 1000 | ppm |
| BIOX-ASDA | 5, 25 | ppm |
| BIOX-C | 5, 25 | ppm |

The paints were inoculated with Pseudomonas aeruginosaATCC 10145 and Enterobacter aerogenes ATCC 13048 at a level of 0.1% inoculum, and paints were then sampled during the next seven days to determine the number of bacterial colonies surviving in the paint. The efficacy of the added antimicrobial agents were given a numeric rating based on the following system: (0) for no bacterial recovery, (1) for trace of contamination (1 to 9 colonies), (2) for light contamination (10 to 99 colonies), (3) for moderate contamination (>100 distinct colonies) and (4) for heavy contamination (continuous smear of growth). The bacterial resistance ratings are presented in Tables 1, 3, and 4.

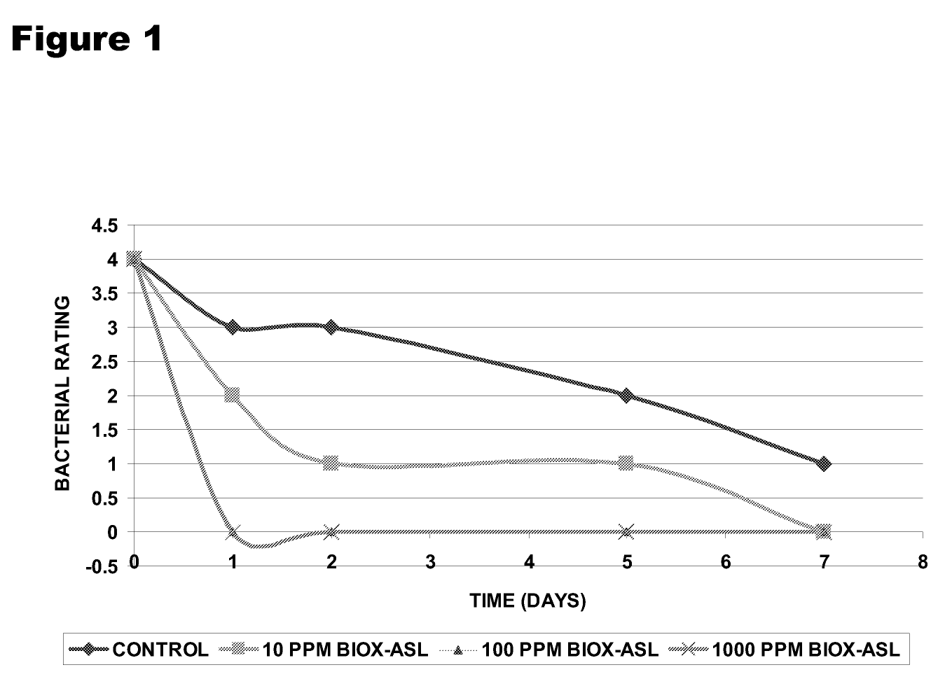

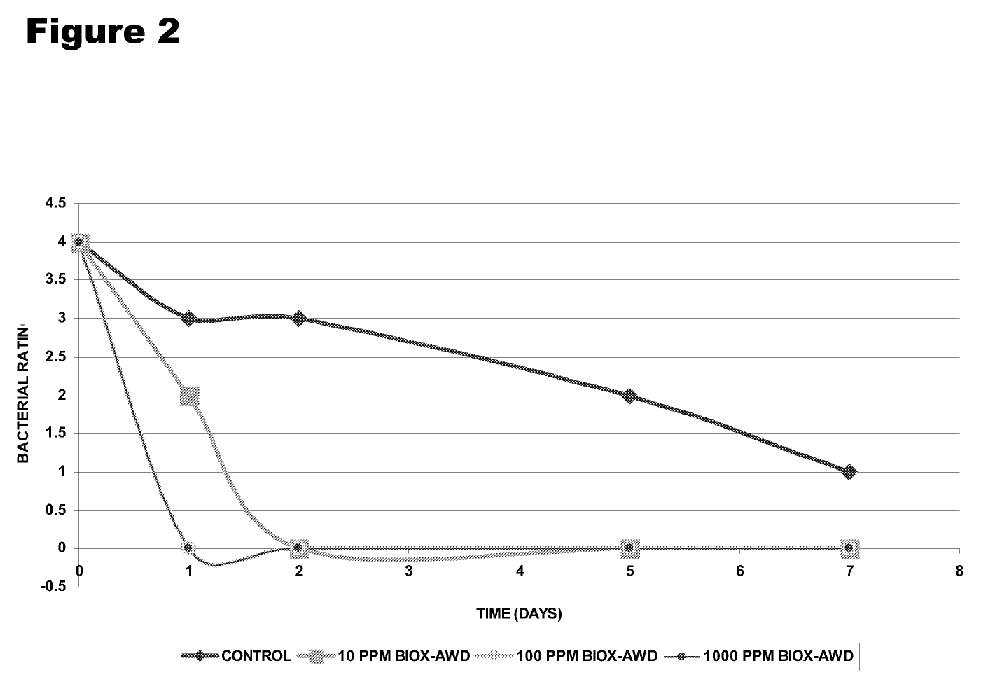

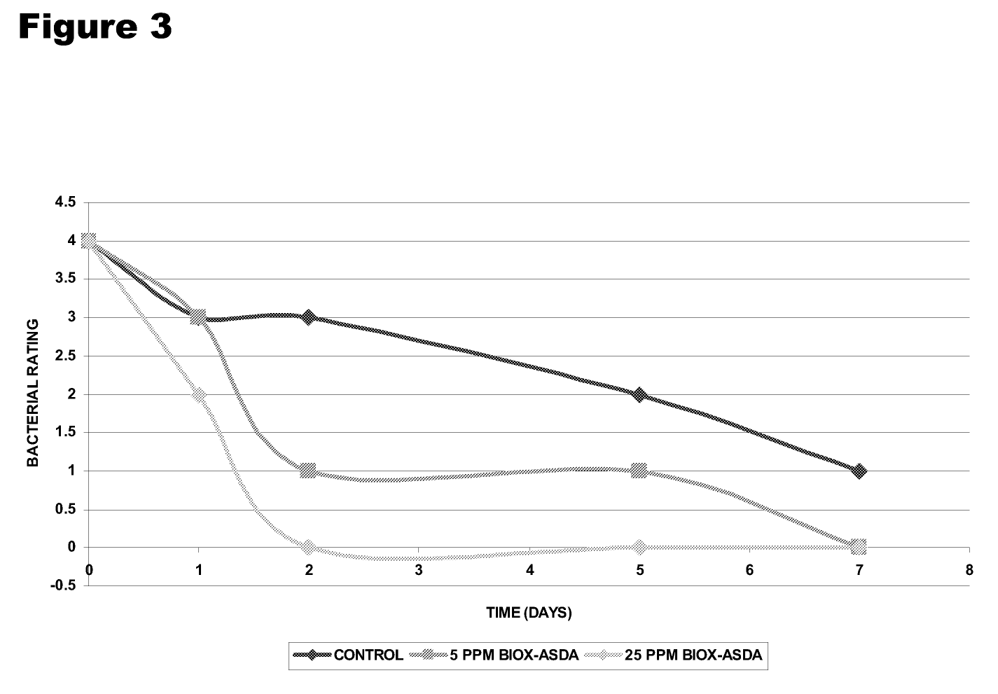

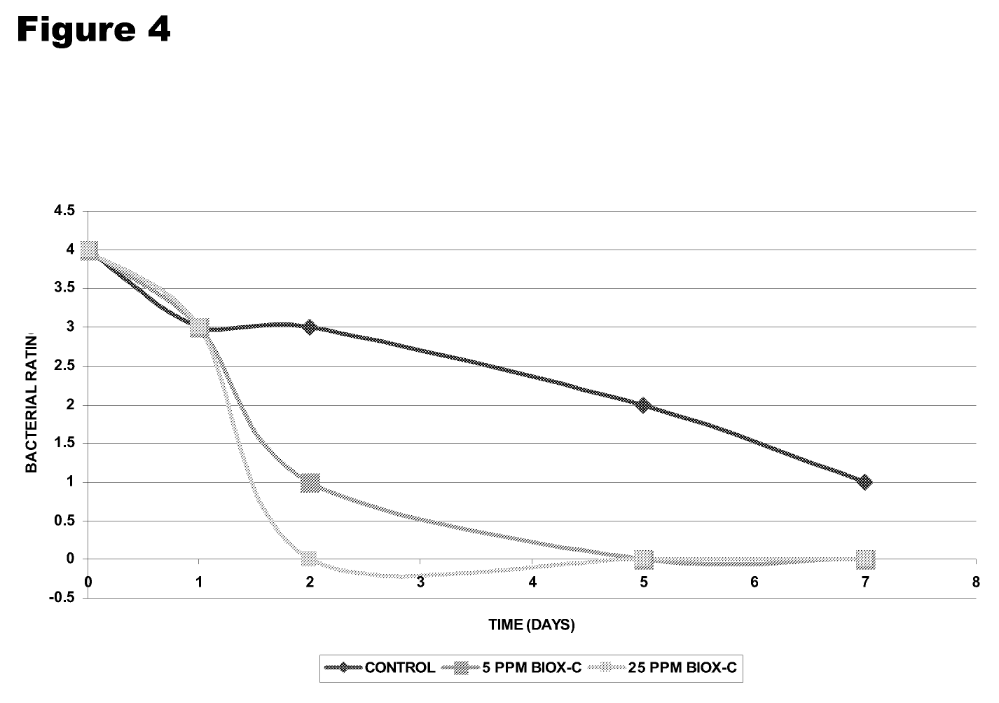

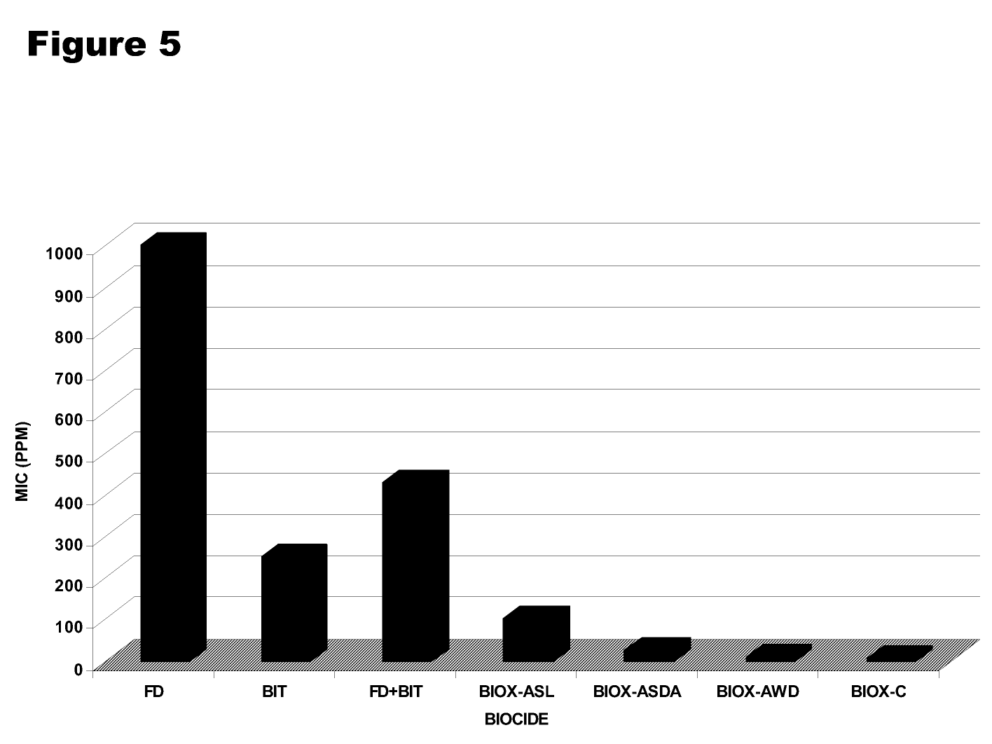

The paints were then inoculated at a level of 1.0% inoculum and were again sampled during the next seven days to determine the number of bacterial colonies surviving in the paint. The bacterial resistance ratings at this inoculum level are presented in Tables 2, 3, and 4. These ratings were also plotted versus day after inoculation for each concentration of BIOX-ASL, BIOX-AWD, BIOX-ASDA, and BIOX-C, and are presented in FIGS. 1-4. The minimum inhibitory concentration (MIC) of each BIOX biocide was much lower after one week than those of commercially available products, as shown in FIG. 5.

TABLE 1
Bacteria Resistance Ratings During Week 1 after 0.1% Inoculum

| | | CBefore | Initial | | | | |
|---|---|---|---|---|---|---|---|
| Sample | | Inoculation | Inoculation | Day 1 | Day 2 | Day 5 | Day 7 |
| Control | | 0 | 4 | 0 | 0 | 0 | 0 |
| 10 | ppm BIOX-ASL | 0 | 4 | 0 | 0 | 0 | 0 |
| 100 | ppm BIOX-ASL | 0 | 4 | 0 | 0 | 0 | 0 |
| 1000 | ppm BIOX-ASL | 0 | 4 | 0 | 0 | 0 | 0 |
| 10 | ppm BIOX-AWD | 0 | 4 | 0 | 0 | 0 | 0 |
| 100 | ppm BIOX-AWD | 0 | 4 | 0 | 0 | 0 | 0 |
| 1000 | ppm BIOX-AWD | 0 | 3 | 0 | 0 | 0 | 0 |
| 5 | ppm BIOX-ASDA | 0 | 4 | 0 | 0 | 0 | 0 |
| 25 | ppm BIOX-ASDA | 0 | 4 | 0 | 0 | 0 | 0 |
| 5 | ppm BIOX-C | 0 | 4 | 0 | 0 | 0 | 0 |
| 25 | ppm BIOX-C | 0 | 4 | 0 | 0 | 0 | 0 |

TABLE 2
Bacteria Resistance Ratings During Week 2 after 1.0% Inoculum

| | | Before | Initial | | | | |
|---|---|---|---|---|---|---|---|
| Sample | | Inoculation | Inoculation | Day 1 | Day 2 | Day 5 | Day 7 |
| Control | | 0 | 4 | 3 | 3 | 2 | 1 |
| 10 | ppm BIOX-ASL | 0 | 4 | 2 | 1 | 1 | 0 |
| 100 | ppm BIOX-ASL | 0 | 4 | 0 | 0 | 0 | 0 |
| 1000 | ppm BIOX-ASL | 0 | 4 | 0 | 0 | 0 | 0 |
| 10 | ppm BIOX-AWD | 0 | 4 | 2 | 0 | 0 | 0 |
| 100 | ppm BIOX-AWD | 0 | 4 | 0 | 0 | 0 | 0 |
| 1000 | ppm BIOX-AWD | 0 | 4 | 0 | 0 | 0 | 0 |
| 5 | ppm BIOX-ASDA | 0 | 4 | 3 | 1 | 1 | 0 |
| 25 | ppm BIOX-ASDA | 0 | 4 | 2 | 0 | 0 | 0 |
| 5 | ppm BIOX-C | 0 | 4 | 3 | 1 | 0 | 0 |
| 25 | ppm BIOX-C | 0 | 4 | 3 | 0 | 0 | 0 |

TABLE 3
Bacterial Resistance Ratings

| | Week 1: 0.1% Inoculum | | | | | Week 2: 1.0% Inoculum | | | | |
|---|---|---|---|---|---|---|---|---|---|---|
| Sample | Initial | Day 1 | Day 2 | Day 5 | Day 7 | Initial | Day 1 | Day 2 | Day 5 | Day 7 |
| Biox-ASL 1.0% | 4 | 4 | 4 | 0 | 0 | 4 | 0 | 0 | 0 | 0 |
| Biox-C 1.0% | 4 | 2 | 0 | 0 | 0 | 4 | 0 | 0 | 0 | 0 |
| Biox-Z 1.0% | 4 | 0 | 0 | 0 | 0 | 4 | 1 | 0 | 0 | 0 |
| HTA 1.0% | 4 | 4 | 4 | 4 | 4 | Discontinued** | | | | |
| *Control | 4 | 4 | 4 | 4 | 4 | 4 | 4 | 4 | 4 | 4 |

*Control was not re-inoculated after initial week of testing to show that the substrate will sustain the bacterial population.
**Samples that showed a viable bacterial population after 7 days contact time, with exception of the Control, were discontinued.

TABLE 4
Bacterial Resistance Ratings

| | Week 1: 0.1% Inoculum | | | | | Week 2: 1.0% Inoculum | | | | |
|---|---|---|---|---|---|---|---|---|---|---|
| Sample | Initial | Day 1 | Day 2 | Day 5 | Day 7 | Initial | Day 1 | Day 2 | Day 5 | Day 7 |
| Biox-ASL 1.0% | 4 | 0 | 0 | 0 | 0 | 4 | 0 | 0 | 0 | |
| Bioban BP30 | 4 | 4 | 4 | 4 | 4 | Discontinued** | | | | |
| Biox-C 1.0% | 4 | 0 | 0 | 0 | 0 | 4 | 0 | 0 | 0 | |
| Biox-Z 1.0% | 4 | 1 | 0 | 0 | 0 | 4 | 1 | 0 | 0 | |
| *Control | 4 | 4 | 4 | 4 | 4 | 4 | 4 | 4 | 4 | 4 |

*Control was not re-inoculated after initial week of testing to show that the substrate will sustain the bacterial population.
** Samples that showed a viable bacterial population after 7 days contact time, with exception of the Control, were discontinued.

### Example 2

Dry-Film Application

Accelerated testing of biocides in paints is conducted using environmental chambers maintained at constant high humidity (85-88% relative humidity) and temperature (30-33° C.). The chamber was primed with spores of Penicillium and Aspergilus sp. to accelerate the formation of fungal organisms. Wood panels are coated with the experimental paints and placed inside the chamber for a period of 4-12 weeks. The relative resistance of the paint to the mold and mildew inside the chamber was evaluated subjectively from a scale of 1 to 10, with 10 being totally free of growth. This test is described in more detail in ASTM D 3273-94 and ASTM D 3274-95.

Paint preservatives listed in table 5 below were added at 1% to alkyd paint formulations. HMTBA-Zn is a zinc metal chelate as described above; HMTBA-Cu is a copper metal chelate as described above; HMTBA-Mn is a manganese metal chelate as described above; BIOX-S is 6-ethoxy-1,2-dihydro-2,2,4-trimethylquinoline; BIOX-A is 88 wt. % HMTBA; BIOX-ASL contains 35 wt. % of 2-hydroxy-4-methylthio butanoic acid (88%), 45 wt. % of formic acid, 10 wt. % phosphoric acid and 10 wt. % lactic acid; and BIOX-EZ/7030 contains 70 wt. % of 6-ethoxy-1,2-dihydro-2,2,4-trimethylquinoline and 30 wt. % of HMTBA-Zn metal chelate. Troy663 is a positive control.

TABLE 5
One month of alkyd paint testing in the environmental chamber

ASTM
RATING

| PRODUCT | Mean | SD |
|---|---|---|
| HMTBA-Zn | | |
| 8.7 | 0.5 | |
| HMTBA-Cu | 9.3 | 0.5 |
| HMTBA-Mn | 7.8 | 0.4 |
| BIOX-S | 9.2 | 0.4 |
| BIOX-A | 9.2 | 0.4 |
| BIOX-ASL | 8.8 | 0.4 |
| BIOX-EZ/7030 | 9.2 | 0.4 |
| Troy 663 | 10 | 0 |
| Control | 8.3 | 0.5 |

TABLE 6
Three months of continuous alkyd paint testing in the environmental
chamber.

| Chemical ID | ASTM Rating |
|---|---|
| BIOX-C | 9.0 ± 0.6 |
| COPPER OMADINE | 9.2 ± 0.4 |
| ZINC-OMADINE | 8.3 ± 0.8 |
| CONTROL | 6.8 ± 0.7 |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description shall be interpreted as illustrative and not in a limiting sense.

What is claimed is:

1. A coating composition comprising an antimicrobial agent and a binder, the antimicrobial agent comprising a hydroxy analog of methionine.

2. The coating composition of claim 1, wherein the hydroxy analog of methionine is a compound comprising Formula 2: 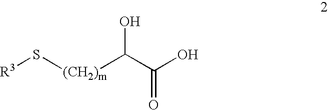
wherein:
R3 is methyl or ethyl; and m is an integer from 0 to 2; and
salts, esters, or amides thereof.

3. The coating composition of claim 2, wherein R3 is methyl and m is 2.

4. The coating composition of claim 2, wherein the compound comprising Formula 2 is present in the coating composition at a concentration of from about 0.0005 wt. % to about 5 wt. %.

5. The coating composition of claim 2, further comprising an additive that is selected from the group consisting of a pigment, filler, a biocide and combinations thereof.

6. The coating composition of claim 2, comprising a paint containing the coating composition.

7. The coating composition of claim 2, wherein the binder comprises a resin selected from the group consisting of acrylic resins, polyvinyl acetate resins, polyurethane resins, epoxy resins, and combinations thereof; and an aqueous solvent.

8. The coating composition of claim 7, wherein the resin is present in the coating composition at a concentration from about 10 wt. % to about 30 wt. %.

9. The coating composition of claim 7, wherein the aqueous solvent comprises water present in the coating composition at a concentration from about 10 wt. % to about 30 wt. %.

10. The coating composition of claim 2, further comprising a metal salt or a metal chelate, the metal chelate or metal salt comprising metal ions and at least one hydroxy analog of methionine.

11. The coating composition of claim 10, wherein the hydroxy analog of methionine is a source of ligand or anion, and is a compound comprising Formula 1: 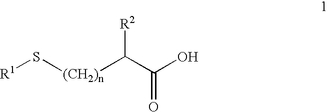
wherein:
R1 is methyl or ethyl;
n is an integer from 0 to 2; and
R2 is selected from the group consisting of hydroxyl and amino.

12. The coating composition of claim 11, comprising a metal chelate wherein the average ligand to metal ion ratio is 2:1; and the metal ion is selected from the group consisting of zinc ions, copper ions, manganese ions, iron ions, chromium ions, nickel ions, silver ions, cobalt ions, sodium ions, calcium ions and combinations thereof.

13. The coating composition of claim 12, wherein the compound of Formula 1 is 2-hydroxy-4-methylthio-butanoic acid; and the metal ion is zinc or copper.

14. The coating composition of claim 10, comprising a metal salt wherein the average anion to metal ion ratio is 1:1; and the metal ion is selected from the group consisting of zinc ions, copper ions, manganese ions, iron ions, chromium ions, nickel ions, silver ions, cobalt ions, sodium ions, calcium ions and combinations thereof.

15. The coating composition of claim 14, wherein the hydroxy analog of methionine is 2-hydroxy-4-methylthio-butanoic acid; and the metal ion is silver or sodium.

16. The coating composition of claim 10, further comprising at least one other antimicrobial agent selected from the group consisting of an organic acid, an inorganic acid, and an auxiliary biocide.

17. The coating composition of claim 2, further comprising an additional organic acid comprising at least one carboxyl moiety and having a pKₐ of less than about 5.5.

18. The coating composition of claim 17, wherein the organic acid is selected from the group consisting of formic acid, acetic acid, propionic acid, butyric acid, benzoic acid, lactic acid, malic acid, tartaric acid, mandelic acid, citric acid, fumaric acid, sorbic acid, boric acid, succinic acid, adipic acid, glycolic acid, glutaric acid, and combinations thereof.

19. The coating composition of claim 17, wherein the organic acid is selected from the group consisting of formic acid, lactic acid, benzoic acid, propionic acid and combinations thereof.

20. The coating composition of claim 17, further comprising at least one other antimicrobial agent selected from the group consisting of a metal salt or metal chelate of a hydroxy analog of methionine, an inorganic acid, and an auxiliary biocide.

21. The coating composition of claim 2, further comprising an inorganic acid selected from the group consisting of phosphoric acid, sulfuric acid, phosphorous acid, hydrochloric acid, hydrobromic acid, nitric acid and combinations thereof.

22. The coating composition of claim 21, wherein the inorganic acid comprises phosphoric acid.

23. The coating composition of claim 21, further comprising at least one other antimicrobial agent selected from the group consisting of a metal salt or metal chelate of a hydroxy analog of methionine, an organic acid, and an auxiliary biocide.

24. The coating composition of claim 2, further comprising an auxiliary biocide selected from the group consisting of formaldehyde releasers, oxazolidines, quaternized salts of hexamethylenetetramine (HTA), bronopol, 1,2 dibromo-2,4dicyanobutane (DBDCB) and combinations thereof.

25. The coating composition of claim 1, wherein the hydroxy analog of methionine comprises a metal salt or a metal chelate.

26. The coating composition of claim 25, wherein the hydroxy analog of methionine is a source of ligand or anion, and is a compound comprising Formula 1: 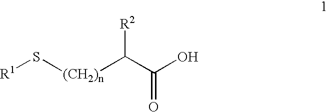
wherein:
R1 is methyl or ethyl;
n is an integer from 0 to 2; and
R2 is selected from the group consisting of hydroxyl and amino.

27. The coating composition of claim 26, comprising a metal chelate wherein the average ligand to metal ion ratio is 2:1; and the metal ion is selected from the group consisting of zinc ions, copper ions, manganese ions, iron ions, chromium ions, nickel ions, silver ions, cobalt ions, sodium ions, calcium ions and combinations thereof.

28. The coating composition of claim 27, wherein the compound of Formula 1 is 2-hydroxy-4-methylthio-butanoic acid; and the metal ion is zinc or copper.

29. The coating composition of claim 26, comprising a metal salt wherein the average anion to metal ion ratio is 1:1; and the metal ion is selected from the group consisting of zinc ions, copper ions, manganese ions, iron ions, chromium ions, nickel ions, silver ions, cobalt ions, sodium ions, calcium ions and combinations thereof.

30. The coating composition of claim 29, wherein the hydroxy analog of methionine is 2-hydroxy-4-methylthio-butanoic acid; and the metal ion is silver or sodium.

31. The coating composition of claim 26, wherein the compound comprising Formula 1 is present in the coating composition at a concentration of from about 0.0005 wt. % to about 5 wt. %.

32. The coating composition of claim 25, further comprising an additive that is selected from the group consisting of a pigment, filler, a biocide and combinations thereof.

33. The coating composition of claim 25, comprising a paint containing the coating composition.

34. The coating composition of claim 25, wherein the binder comprises a resin selected from the group consisting of acrylic resins, polyvinyl acetate resins, polyurethane resins, epoxy resins, and combinations thereof; and an aqueous solvent.

35. The coating composition of claim 34, wherein the resin is present in the coating composition at a concentration from about 10 wt. % to about 30 wt. %.

36. The coating composition of claim 34, wherein the aqueous solvent comprises water present in the coating composition at a concentration from about 10 wt. % to about 30 wt. %.

37. The coating composition of claim 25, further comprising a hydroxy analog of methionine that is a compound comprising Formula 2: 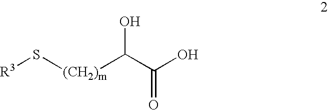
wherein:
R3 is methyl or ethyl; and
m is an integer from 0 to 2; and
salts, esters, or amides thereof.

38. The coating composition of claim 25, further comprising at least one other antimicrobial agent selected from the group consisting of an organic acid, an inorganic acid, and an auxiliary biocide.

39. The coating composition of claim 25, further comprising an additional organic acid comprising at least one carboxyl moiety and having a pKa of less than about 5.5.

40. The coating composition of claim 39, wherein the organic acid is selected from the group consisting of formic acid, acetic acid, propionic acid, butyric acid, benzoic acid, lactic acid, malic acid, tartaric acid, mandelic acid, citric acid, fumaric acid, sorbic acid, boric acid, succinic acid, adipic acid, glycolic acid, glutaric acid, and combinations thereof.

41. The coating composition of claim 39, wherein the organic acid is selected from the group consisting of formic acid, lactic acid, benzoic acid, propionic acid and combinations thereof.

42. The coating composition of claim 39, further comprising at least one other antimicrobial agent selected from the group consisting of an organic acid, an inorganic acid, and an auxiliary biocide.

43. The coating composition of claim 25, further comprising an inorganic acid selected from the group consisting of phosphoric acid, sulfuric acid, phosphorous acid, hydrochloric acid, hydrobromic acid, nitric acid and combinations thereof.

44. The coating composition of claim 43, wherein the inorganic acid comprises phosphoric acid.

45. The coating composition of claim 44, further comprising at least one other antimicrobial agent selected from the group consisting of an organic acid, an inorganic acid, and an auxiliary biocide.

46. The coating composition of claim 25, further comprising an auxiliary biocide selected from the group consisting of formaldehyde releasers, oxazolidines, quaternized salts of hexamethylenetetramine (HTA), bronopol, 1,2 dibromo-2,4dicyanobutane (DBDCB) and combinations thereof.

47. A method for inhibiting microbial growth and/or replication in a coating composition, the method comprising adding an antimicrobial composition to the coating composition, the antimicrobial composition comprising a hydroxy analog of methionine and a binder.

48. The method of claim 47, wherein the coating composition comprises a paint that is a waterborne paint or an alkyd-based paint.

49. The method of claim 47, wherein the hydroxy analog of methionine is present in the antimicrobial composition at a concentration of from about 0.0005 wt. % to about 5 wt. %.

50. The method of claim 47, wherein the antimicrobial composition further comprises an additive that is selected from the group consisting of a pigment, filler, a biocide and combinations thereof.

51. The method of claim 47, wherein the binder comprises a resin selected from the group consisting of acrylic resins, polyvinyl acetate resins, polyurethane resins, epoxy resins, and combinations thereof; and an aqueous solvent.

52. The method of claim 51, wherein the resin is present in the antimicrobial composition at a concentration from about 10 wt. % to about 30 wt. %.

53. The method of claim 51, wherein the aqueous solvent comprises water present in the antimicrobial composition at a concentration from about 10 wt. % to about 30 wt. %.

54. The method of claim 47, wherein the hydroxy analog of methionine is a compound comprising Formula 2: 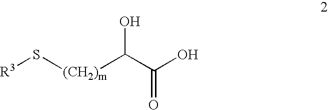
wherein:
R3 is methyl or ethyl; and
m is an integer from 0 to 2; and
salts, esters, or amides thereof.

55. The method of claim 54, wherein R3 is methyl and m is 2.

56. The method of claim 54, further comprising at least one other antimicrobial agent selected from the group consisting of a metal chelate or metal salt of a hydroxy analog of methionine, an organic acid, an inorganic acid, and an auxiliary biocide.

57. The method of claim 54, wherein the hydroxy analog of methionine comprises a metal salt or a metal chelate.

58. The method of claim 57, wherein the hydroxy analog of methionine is a source of ligand or anion, and is a compound comprising Formula 1: 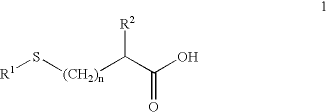
wherein:
R1 is methyl or ethyl;
n is an integer from 0 to 2; and
R2 is selected from the group consisting of hydroxyl and amino.

59. The method of claim 58, comprising a metal chelate wherein the average ligand to metal ion ratio is 2:1; and the metal ion is selected from the group consisting of zinc ions, copper ions, manganese ions, iron ions, chromium ions, nickel ions, silver ions, cobalt ions, sodium ions, calcium ions and combinations thereof.

60. The method of claim 58, wherein the compound of Formula 1 is 2-hydroxy-4-methylthio-butanoic acid; and the metal ion is zinc or copper.

61. The method of claim 58, comprising a metal salt wherein the average anion to metal ion ratio is 1:1; and the metal ion is selected from the group consisting of zinc ions, copper ions, manganese ions, iron ions, chromium ions, nickel ions, silver ions, cobalt ions, sodium ions, calcium ions and combinations thereof.

62. The method of claim 61, wherein the hydroxy analog of methionine is 2-hydroxy-4-methylthio-butanoic acid; and the metal ion is silver or sodium.

63. The method of claim 57, further comprising at least one other antimicrobial agent selected from the group consisting of a metal chelate or metal salt of a hydroxy analog of methionine, an organic acid, an inorganic acid, and an auxiliary biocide.

64. The method of claim 47, wherein the antimicrobial composition further comprises at least one other antimicrobial agent selected from the group consisting of a metal chelate or metal salt of a hydroxy analog of methionine, an organic acid, an inorganic acid, and an auxiliary biocide.

65. The method of claim 64, wherein the additional antimicrobial agent is an organic acid comprising at least one carboxyl moiety, having a pKa of less than about 5.5, and is selected from the group consisting of formic acid, acetic acid, propionic acid, butyric acid, benzoic acid, lactic acid, malic acid, tartaric acid, mandelic acid, citric acid, fumaric acid, sorbic acid, boric acid, succinic acid, adipic acid, glycolic acid, glutaric acid, and combinations thereof.

66. The method of claim 64, wherein the additional antimicrobial agent is an inorganic acid selected from the group consisting of phosphoric acid, sulfuric acid, phosphorous acid, hydrochloric acid, hydrobromic acid, nitric acid and combinations thereof.

67. The method of claim 64, wherein the additional antimicrobial agent is an auxiliary biocide selected from the group consisting of formaldehyde releasers, oxazolidines, quaternized salts of hexamethylenetetramine (HTA), bronopol, 1,2 dibromo-2,4dicyanobutane (DBDCB) and combinations thereof.

68. A coating composition comprising an antimicrobial agent and a binder, the antimicrobial agent comprising a metal chelate, the metal chelate comprising zinc ions or copper ions and at least one hydroxy analog of methionine that is a ligand source, the hydroxy analog of methionine comprising 2-hydroxy-4-methylthio-butanoic acid.

69. The coating composition of claim 69, wherein the metal chelate is present in the coating composition at a concentration of from about 0.0005 wt. % to about 5 wt. %.

70. The coating composition of claim 68, further comprising an additive that is selected from the group consisting of a pigment, filler, a biocide and combinations thereof.

71. The coating composition of claim 68, comprising a paint containing the coating composition.

72. The coating composition of claim 68, wherein the binder comprises a resin selected from the group consisting of acrylic resins, polyvinyl acetate resins, polyurethane resins, epoxy resins, and combinations thereof; and an aqueous solvent.

73. The coating composition of claim 72, wherein the resin is present in the coating composition at a concentration from about 10 wt. % to about 30 wt. %.

74. The coating composition of claim 72, wherein the aqueous solvent comprises water present in the coating composition at a concentration from about 10 wt. % to about 30 wt. %.

75. The coating composition of claim 68, wherein the antimicrobial composition further comprises at least one other antimicrobial agent selected from the group consisting of a metal salt, anions, a hydroxy analog of methionine, an organic acid, an inorganic acid, and an auxiliary biocide.

76. The coating composition of claim 75, wherein the additional antimicrobial agent is an organic acid comprising at least one carboxyl moiety, having a pKa of less than about 5.5, and is selected from the group consisting of formic acid, acetic acid, propionic acid, butyric acid, benzoic acid, lactic acid, malic acid, tartaric acid, mandelic acid, citric acid, fumaric acid, sorbic acid, boric acid, succinic acid, adipic acid, glycolic acid, glutaric acid, and combinations thereof.

77. The coating composition of claim 75, wherein the additional antimicrobial agent is an inorganic acid selected from the group consisting of phosphoric acid, sulfuric acid, phosphorous acid, hydrochloric acid, hydrobromic acid, nitric acid and combinations thereof.

78. The coating composition of claim 75, wherein the additional antimicrobial agent is an auxiliary biocide selected from the group consisting of formaldehyde releasers, oxazolidines, quaternized salts of hexamethylenetetramine (HTA), bronopol, 1,2 dibromo-2,4dicyanobutane (DBDCB) and combinations thereof.

79. The coating composition of claim 75, wherein the metal salt is selected from the group consisting of zinc chloride, zinc nitrate, zinc carbonate, zinc sulfate, zinc acetate, zinc formate, zinc ammonium sulfate, zinc phosphate, zinc stearate, and combinations thereof.

80. The coating composition of claim 75, wherein the anion is selected from the group consisting of chloride, nitrate, carbonate, sulfate, acetate, formate, ammonium sulfate, phosphate, stearate, and combinations thereof.

81. The coating composition of claim 68, wherein the average particle size of the metal chelate is from about 0.05 to about 8 microns.
